(19) United States
(12) Patent Application Publication
(10) Pub. No.: US 2009/0138288 A1
(43) Pub. Date: May 28, 2009

(54) Best system of health & health-care data management

(76) Inventor: Anuthep Benja-Athon, New York, NY (US)

Correspondence Address: ANUTHEP BENJA-ATHON, M.D., 210 E. 36th St., NEW YORK, NY, 10016, US

(21) Appl. No.: 12/321,141

(22) Filed: Jan. 16, 2009

Related U.S. Application Data
(63) Continuation-in-part of application No. 12/069,409, filed on Feb. 11, 2008.
Application No. 12/069,409 is a continuation-in-part of application No. 11/986,657, filed on Nov. 26, 2007.
Application No. 11/986,657 is a continuation-in-part of application No. 11/803,621, filed on May 16, 2007.
Application No. 11/803,621 is a continuation-in-part of application No. 11/716,062, filed on Mar. 9, 2007.
Application No. 11/716,062 is a continuation-in-part of application No. 11/649,873, filed on Jan. 5, 2007, now abandoned.
Application No. 11/649,873 is a continuation-in-part of application No. 11/637,662, filed on Dec. 13, 2006.
Application No. 11/637,662 is a continuation-in-part of application No. 11/599,847, filed on Nov. 16, 2006.
Application No. 11/599,847 is a continuation-in-part of application No. 11/431,046, filed on May 10, 2006.
Application No. 11/431,046 is a continuation-in-part of application No. 11/543,895, filed on Oct. 6, 2006.
Application No. 11/543,895 is a continuation-in-part of application No. 11/523,945, filed on Sep. 21, 2006.
Application No. 11/523,945 is a continuation-in-part of application No. 11/510,820, filed on Aug. 28, 2006.
Application No. 11/510,820 is a continuation-in-part of application No. 11/477,121, filed on Jun. 29, 2006.
Application No. 11/477,121 is a continuation-in-part of application No. 11/114,763, filed on Apr. 27, 2005.
Application No. 11/114,763 is a continuation-in-part of application No. 11/196,823, filed on Aug. 4, 2005.
Application No. 11/196,823 is a continuation-in-part of application No. 11/973,866, filed on Oct. 11, 2007.
Application No. 11/973,866 is a continuation-in-part of application No. 11/293,689, filed on Dec. 5, 2005.
Application No. 11/293,689 is a continuation-in-part of application No. 11/150,878, filed on Jun. 13, 2005.
Application No. 11/150,878 is a continuation-in-part of application No. 11/074,236, filed on Mar. 7, 2005.
Application No. 11/074,236 is a continuation-in-part of application No. 11/022,410, filed on Dec. 27, 2004, now abandoned.

(51) Int. Cl. G06Q 50/00

(52) U.S. Cl. 705/3

(57) ABSTRACT

A method of using interactive and related electronic templates created, maintain and operate by an innovative computer program for generating, storing, relating, manipulating, updating and expanding health, health-care and health-care service information and data on patients by patients, physicians and pharmacists.

This application is a continuation-in-part of 12/069,409 entitled the Filing of Health and Heath-care data filed Feb. 11, 2008, continuation-in-part of 11/986,657 entitled A hierarchy of medical word headers filed Nov. 26, 2007, a continuation-in-part of 11/803,621 entitled Patients' and physicians' data management filed May 16, 2007, a continuation-in-part of 11/716,062 entitled A sieve of words in health-care data filed Mar. 9, 2007, a continuation-in-part of 11/649,873 entitled A system of calibrating physicians' practices of medicine filed Jan. 5, 2007, a continuation-in-part of 11/637,662 entitled A vital hierarchy of data on diseases filed Dec. 13, 2006, a continuation-in-part of 11/599,847 entitled A hybrid intelligence in medicine filed Nov. 16, 2006, a continuation-in-part of 11/431,046 entitled A system of health-care information management filed Nov. 2, 2006, a continuation-in-part of 11/543,895 entitled Vital elements of speech recognition filed Oct. 6, 2006, a continuation-in-part of 11/523,945 entitled The networking of digital health information filed Sep. 21, 2006, a continuation-in-part of 11/510,820 entitled Words for managing health and health-care information filed Aug. 28, 2006, a continuation-in-part of 11/477,121 entitled the Medical Vocabulary Templates in Speech Recognition filed Jun. 29, 2006, a continuation-in-part of Fidelity of physicians' thoughts to digital data conversions filed Jan. 9, 2006, a continuation-in-part of 11/114,763 entitled A system of influencing health-care utilizations filed Apr. 27, 2005, a continuation-in-part of 11/196,823 entitled Routing of health information files filed Aug. 4, 2005, a continuation-in-part of 11/973,866 entitled An intelligent system of speech recognizing physicians' data, a continuation-in-part of 11/293,689 entitled A system of conserving health-care buyers' resources filed Dec. 5, 2005, a continuation-in-part of 11/150,878 entitled Physicians' optimal management of health information filed Jun. 13, 2005, a continuation-in-part of 11/074,236 entitled A system of management of health-care resources filed Mar. 7, 2005 and a continuation-in-part of 11/022,410 entitled Physicians' way of information productions filed Dec. 27, 2004.

### FIELD OF INVENTION

An electronic platform for and a method of communications and interactions between patients and physicians in health-care.

### BACKGROUND OF THE INVENTION

The concepts of and means for generating and managing health and health-care data and information on patients by physicians and the incorporations into and relations of said data and information to the larger health and health-care data and information generated by patients and physicians are taught in said pending patent applications.

However, the system and method of using the means for filing, relating, managing and expanding health, health-care and health-care-service information and data on patients and physicians and for effecting the associations, incorporations, relations and managements of said information and data by said patients, physicians and computer servers were heretofore either not achieved, described or not detailed. Therefore, the present invention provides a system and a method to achieve the objectives and goals described herein.

The present invention together with said pending patent applications are the only means and solution for solving the current health and health-care woes affecting all Americans and, consequently, they produce the best health-care system the world ever known and have and the benefits for billions of people and humanity are immense.

### SUMMARY OF THE INVENTION

The present invention provides the best means for managing health, health-care and health-care service information and data by patients and physicians resulting in the best health-care system the world ever known and immensely benefits billions of people and humanity.

The present invention provides a method of implementing and using numerous interactive electronic interfaces or templates—an electronic platform—comprising word and term headers and related words, terms, phrases, sentences, word and term headers, texts and graphics, text-based interfaces and graphical user interfaces generated, maintain and support by an innovative computer software and program means for generating, storing, relating, manipulating, updating and expanding health, health-care and health-care service information and data on patients by said patients and physicians and pharmacists wherein said information and data are entered, stored, related, updated and expanded in the database or databases generated, maintain and support by said software and program means operating in a computer server or serves in a network or networks of computer servers and computers and wherein said information and data can be viewed and used by patients and physicians for managing information and data on health, health-care and health-care services.

### DESCRIPTION OF THE PREFERRED EMBODIMENTS

The present invention provides a method and an electronic platform means for generating, storing, relating, manipulating, updating and expanding health, health-care and health-care service information and data on patients and physicians by said patients, physicians and pharmacists and database means for generating, storing, relating, manipulating, updating and expanding said information and data which are created, enabled, supported and maintained by an innovative computer software and program invented and created and are functioning by the present patent applicant. Said electronic platform—partially viewable at www.UnitedPhysicians.com™ henceforth UP registered to the present patent applicant and is owned and operated by the present patent applicant—are created, enabled, supported and maintained by said innovative computer software and program.

The present invention comprises numerous interactive electronic interfaces or templates henceforth templates comprising at least three primary templates. First, the first primary templates, although one of its preferred embodiments with details and links such as, but not limited, Edit, View, Laboratories, Imaging and other templates infra can be better viewed live at UP via https://unitedphysicians.com/PatientsMedicalRecord.php?continueToMedicalRecord=Co ntinue+to+Medical+Record, which is schematically showing some word and term headers represent infra by bold Arial words and terms and related functions as represented as follows:

Tag Means
Patient's health and health-care information and data summary
Past Medical History “Edit”
“Add”
Past Surgical History “Edit”
“Add”
Allergy “Edit”
“Add”
Food and Chemical Sensitivities “Edit”
“Add”
Evaluation “Edit”
“Add”
Family History “Edit”
“Add”
Chief Complaints “Edit”
“Add”
Review of Systems “Edit”
“Add”
Physical Examinations “Edit”
“Add”
Diagnoses “Edit”
“Add”
Infectious Diseases “Edit”
“Add”
Differential Diagnoses “Edit”
“Add”
Laboratories “Edit”
“Add”
Assessment and Plan “Edit”
“Add”
Medications “Edit”
“Add”
Treatments “Edit”
“Add”
Surgical History “Edit”
“Add”
Recommendations “Edit”
“Add”
Referrals “Edit”
“Add”
Follow-Ups “Edit”
“Add”

Each “______” represents an interactive box which enables a patient owner of said template and, later, said patient's access-authorized physicians to enter said information and data and to use the click buttons such as, but not limited to, the “Add”, “Edit”, “View”, etc. and the like to access other templates infra to generate, relate, manipulate, update and expand said patient's health, health-care and health-care service information and data and to submit said information and data to said database means.

Link and relate to said word and terms headers in said first templates are numerous secondary templates and pop-up and/or drop-down lists and/or menus of words, terms, phrases, sentences, texts and graphics such as, but not limited to, U.S. Pat. No. 6,132,218 granted to the present patent applicant and relating and linking to the contents of said first and other templates infra viewable on the viewing screens of said devices and useable by said patients and physicians. Although it has been described in pending earlier patent applications, said data and information are words, terms, word and term headers and topics and subjects as shown above such as, but not limited to, Evaluation, Chief Complaints, Review of Systems, Diagnoses, Differential Diagnoses, Physical Examinations, Medications, Treatments, Surgeries, etc., phrases, synonyms, codes, numbers, sentences, texts and graphic, etc. used and use by physicians in all—approximately 85—medical and surgical specialties and practices to describe and document data and information on diseases, illnesses, disorders, health and health-care of patients and health-care services. At least Java Script and AJAX are used to support said templates, lists and menus.

Second, the present invention provides the second primary templates comprising said word and term headers and related functions represent by bold Arial words and terms infra and text-based interfaces and graphical user interfaces such as, but not limited to, U.S. Pat. No. 6,132,218—as schematically abbreviated in one of its preferred embodiments infra—viewable useable by and interactive with physicians and computer software and program means for effecting said processes and products and relating the contents of said information and data in said first templates and other templates infra and in said database means as follows:

Prefixes Suffixes Numbers Time Chronicity Temperature
Medication Dosages Units AdministrationRoutes Frequencies
Tag Means
Evaluation Secondary Template Evaluation
Chief Complaint Secondary Template Chief Complaint
Review of Systems Secondary Template Review of Systems
Physical Examination Secondary Template Physical Examination
Diagnosis Secondary Template Diagnosis
Infectious Diseases Secondary Template Infectious Diseases
Differential Diagnosis Secondary Template Differential
Diagnosis
Laboratories Secondary Template Laboratories
Assessment and Plan Secondary Template Assessment and Plan
Medications Secondary Template Medications
Treatment Secondary Template Treatment
Surgery Secondary Template Surgery
Recommendation Secondary Template Recommendation
Referral Secondary Template Referral
Follow-Up Secondary Template Follow-Up
Submit button
Said patient clicks Submit sending said information and data into said database or databases.

Said Prefixes, Suffixes, Numbers, Time, Medication Dosages, Units, AdministrationRoutes and Frequencies represent tens to hundreds of interactive prefixes and suffixes—support by said computer software and program and JAVA Script—such as, but not limited to, sidedness such as left, right, bilateral, contralateral, 1, 2, 3, 4, 5, 6, 7, 8, 9, 0, milligrams, c.c., oral, parenteral, bid, tid, qid and the like, etc. applicable to be related or entered with the contents entered to the right of said word and term headers

Each “______” an interactive box which enables said physicians to enter—by using the contents in said secondary templates in said second templates or, less preferred, by keyboarding—and relate health, health-care and health-care service information and data on patients into said database means and the transformations of said first templates into the third templates—in other words, the retrievals of said second information and data generated by physicians and assimilations and/or incorporations into the contents of said first templates thus updating, enlarging, changing and improving the contents of said first templates comprising said information and data repetitively generated by physicians and patients after said first templates were used by said patients.

One of the preferred embodiments of the present invention, link and relate to said word and terms headers in said second templates are said first primary templates and other primary and secondary templates to the right of “______” supra comprising pop-up and/or drop-down lists and/or menus of words, terms, phrases, sentences, texts, synonyms, acronyms and graphics such as, but not limited to, U.S. Pat. No. 6,132,218 granted to the present patent applicant and relating and linking to the contents of said first and other templates infra viewable on the viewing screens of said devices and useable by said physicians. Although it has been described in pending earlier patent applications, said word and term headers and related and linked words, terms, phrases, sentences, synonyms, acronyms, texts, numbers, and graphics, etc. are used and use by physicians in all—approximately 85—medical and surgical specialties and practices to describe and document data and information on diseases, illnesses, disorders, health and health-care of patients and health-care services.

Furthermore, said computer software and program means create the fourth primary templates comprising at least four types of templates—one of which are partially synthesized by physicians and one of which are partially synthesized by patients and yet one of which partially synthesized by said computer software and program means and yet the fourth one of which are artificial-intelligently created or synthesized by said computer software and program means derived from and/or based on the information and data used by physicians wherein words, terms, phrases, sentences, texts and graphics relating to said information and data in said templates and database or databases are used by patients and physicians to enter health, health-care and health-care-service information and data into said database or databases and repetitive assimilations or incorporations of said information and data into said primary templates or otherwise known as the third template after said processes per said discussion. Said fourth templates may be used in lieu of or in combination with said second templates by physicians in generating second information and data on health, health-care and health-care services performed by said physicians and then storing, relating in said database means and retrieving, relating, manipulating and expanding said first primary templates to achieve said third templates per said discussion.

Said computer software and program effect the entries and storage of submitted said information and data generated by physicians into said database means and relate said information and data with said first information and data which are retrieved and incorporated by said software and program and placing said information and data into said first templates transforming said first templates into the third templates—in other words, the retrievals of said second information and data generated by physicians and assimilations and/or incorporations into the contents of said first templates thus updating, enlarging, changing and improving the contents of said first templates comprising said information and data repetitively generated by physicians and patients after said first templates were used by said patients. The transformations of said first primary templates into said third primary templates or the generations of said third templates and the updating, enlarging, manipulating, improving are created, maintained and supported by said computer software and program which implement the repetitive uses and submissions by physicians of said second and fourth primary templates and said secondary templates resulting in perpetual said expansions, updates and improvements of said third primary templates.

An example of infinite number of products infra, one of the preferred embodiments of the present invention, a patient owner of a first template enters the following contents into his or her first template using the “Add” buttons to access other templates infra relating to each word and term header infra so that the first template comprising his or her health and health-care information and data wherein his or her electronic medical record is formed and schematically and briefly represented or approximated but better represented at https://unitedphysicians.com/PatientsMedicalRecord.php?continueToMedicalRecord=Co ntinue+to+Medical+Record as follows:

One of the preferred embodiments of the present invention, a second primary template is used by Henry Goldsmith, M.D. who is a physician of John Doe supra to produce health and health-care information and data on John Doe as schematically and briefly represented or approximated as follows:

The assimilation or incorporation of said second information and data in second primary template as schematically represented in FIG. 2 with related said first information and data as schematically represented in FIG. 1 transform said first primary template into said third primary template as schematically represented as follows:

Said repetitive processes imposed on said second templates by said physicians and said repetitive processes imposed on said third templates by said patients, physicians and computer software and program means repetitively effect said processes and productions resulting in perpetual said expansions, updates and improvements of said third primary templates.

In addition, one of the preferred embodiments of the present invention has numerous fifth primary templates comprising words, terms, phrases, sentences, word and term headers, texts and graphics comprising text-based interfaces and graphical user interfaces link and/or relate to said primary templates and show information and data including details relate to said information and data in said primary templates wherein said fifth primary templates are used by physicians and patients to manipulate, update and improve said primary templates, such as, but not limited to, said third primary templates by said physicians and patients.

Furthermore, click buttons such as, but not limited to, the “Add”, “Edit”, “View” and “Submit” buttons and the like to access primary and secondary templates to generate, relate, manipulate, update and expand said patient's health, health-care and health-care service information and data and to submit said information and data to said database means by said physicians and patients resulting in perpetual said expansions, updates and improvements of said third primary templates viewable by said physicians and patients.

Said computer software and program create and effect the management of tests and laboratories such as, but not limited to, MRI, CTScan, blood tests wherein the entire process such as, but not limited to, an interactive scheduling between testing and laboratory physicians such as, but not limited to, radiologists, pathologists, testing laboratories, neurologists, gastroenterologists, physiatrists and the patients so that all orders of tests by physicians, the scheduling of tests between patients and test and/or laboratory physicians and their clinics or laboratories, the results of tests and the posting of the results of tests are achieved and/or produced using templates described herein and wherein said templates viewable by said patients and physicians or the technicians also show health information and data on patients such as, but not limited to, allergies, drug and food sensitivities and surgical implanted devices in said patients, past medical history, past surgical history, chief complaint or chief complaints and durations or durations, diagnoses, differential diagnoses. Said functions, processes, products and results can be implemented and used from any and several said primary and/or secondary templates. For example, in the current implementation, said functions, processes, products and results are accessed and used by said patients and physicians from said third templates and/or related secondary templates, by said physicians from the second templates and related secondary templates.

Similarly, furthermore, said computer software and program also create and effect the management of prescriptions and dispensations of medications wherein the entire process of prescriptions of the medications to the documentations of prescriptions by the pharmacists—prescriptions are prescribed by physicians, ordered by patients or physicians, patients or physicians directing prescriptions to pharmacists, notifications and records of the dispensations of medications by pharmacists to patients and physicians including times and dates of dispensations—are produced and documented in and supported by the templates described herein wherein said templates viewable by said patients, physicians and pharmacists also show health information and data on patients such as, but not limited to, allergies, drug and food sensitivities, past medical history, past surgical history, diagnoses, and medications which patients have taken and are taking. Said functions, processes, products and results can be implemented and used from any and several said primary and/or secondary templates. For example, in the current implementation, said functions, processes, products and results are accessed and used by said patients and physicians from said third templates and/or related secondary templates, by said physicians from the second templates and related secondary templates, and the pharmacists and/or their assistants can accessed and used said functions, processes, products and results and related from their electronic pages and/or templates created, maintain and operate by said computer software and program.

Moreover, in said settings and circumstances using said features in said templates, prescribing physicians, laboratory physicians such as, but not limited to radiologists and pathologists, pharmacists and patients can send back and forth between said parties queries, choices and options and responses with regards to appointments and schedules and prescribing, ordering, fulfilling of prescriptions and records of dispensations of medications as the cases may be.

It is to be understood that the present invention comprising system, method, processes, platform, means, matters, products, functions and related and derivatives—implemented, effect and operate by said innovative computer software and program operating in said computer server or servers—are far more complex, extensive, intelligent, versatile and more than two dimensional and more versatilely, logically and relationally organized, arranged and presented than said brief and simple representations herein.

The method, processes, platform, matters, products, functions and related and derivatives of the present invention are implemented and effected by said innovative computer software and program invented and developed by the present patent applicant which were filed with and are stored in the Library of Congress in Washington, D.C. and at least one computer server of the present patent applicant and will be implemented computer server or servers in the network or networks of computer servers, computers, mobile communication devices and the like in 2009 and beyond and are useable as described in the present patent application in the domain of www.UnitedPhysicians.com owned and operated by the present patent applicant capable of changing, transforming and improving the health and health-care system and standard of living for hundreds of millions of people in USA and other nations. The present invention uses also the commercially available computer software (plural), programs and computer languages such as, but not limited to, those made and sold by Microsoft Corporation such as, but not limited to, Microsoft Windows Server, SQL such as, but not limited to Microsoft SQL Server, MySQL and the like, Internet Explorer, browsers, Web server, Apache, Microsoft IIS, Visual Studio and .Net, Microsoft software including .txt program and their derivatives and the like and their database, databases and derivatives, other computer corporations' and companies' programs, languages, codes and databases and their derivatives which are commonly and routinely used by computer engineers and programmers such as, but not limited to, PHP, PERL, C languages, such as, but not limited to, C, C+, C++, C#, JAVA, Java Script, AJAX, HTML, XHTML and the like and related and their derivatives. Other security software are such as, but not limited to, encryption-decryption of the information and data infra and their derivatives and products, processes and software, Firewall, anti-viral and related, Secure Sockets Layer (SSL) or Transport Layer Security (TLS) and related and the like and their derivatives.

The standard commercial hardware and equipment being used in the TCP/IP networks such as, but not limited to, the Internet commerce are implemented and deployed per standard industrial practices and use hardware and equipment such as, but not limited to, computer servers and computers such as numerous HP and IBM servers, HP and Dell computers, Cisco routers and related, and various equipment including modems sold, lease, own and operate by cable companies such as, but not limited to, Time Warner and Optimum Online in New York, etc. Currently, HP ProLiant ML350 and ML110 Generation 4p Servers—see www.hp.com for details of the server hardware and internal design—and similar Dell server—see www.dell.com for details of the server hardware and internal design—used by the present patent applicant as the hardware wherein the computer programs and software(s) mentioned herein operate. It is obvious and known that with more extensive operations and requirements, server blades and various hardware and equipment configurations, virtual servers such as those sold by VMware, HP and IBM, and their derivatives being used by many large American corporations can and will be used to implement the present invention.

Consequent to the incorporations of said data and information using computer programs, software mentioned herein and the like, the products of said incorporations are stored in and retrieved from database or databases to be displayed on the viewing screens and comprehensible and use by patients and physicians.

It is understood that—by laws and ethics applicable to the present invention and said descriptions of the preferred embodiments—health, health-care and health-care service data and information on individual patients belongs or relates to said individual patients and are generated and safeguarded by physicians who are authorized by same to safeguard and to access and view said data and information.

Although various preferred embodiments of the present invention have been described, it will be appreciated by those skilled in the art that their adaptations, variations and derivatives may be made and achieved without departing from the spirit and the scope of the claims of the present invention.

1. A method of generating, storing, relating, manipulating and expanding first health, health-care and health-care service information and data on patients by said patients and physicians and second information and data on health, health-care and health-care services performed by said physicians on patients and third information and data on physicians' prescriptions of medications and testings and test results generated by physicians, and a method of relating said information and data in the computer server or servers and/or computers of a network or networks of computer servers, computers and portable communication devices henceforth devices and for retrieving said information and data from said database or databases for displays on the viewing screens of said devices for viewing, inspecting, manipulating, editing, expanding, updating and improving by and communications among said patients and physicians wherein an innovative computer software and program means for generating, relating, entering, storing, retrieving, manipulating, expanding and updating said information and data implemented in said devices and said database or databases and for generating, manipulating, expanding, updating said database or databases and for displaying said information and data are used to implement said processes and products in said computer servers and/or computers and an electronic platform comprising said information and data, processes, matters, events and products and said database or databases and those described infra and their derivatives, wherein said platform comprises (1) said database or databases, (2) words and terms also known as word and term headers in health, health-care and health-care-service information and data, (3) numerous primary interactive electronic interfaces or templates henceforth primary templates comprising at least three primary templates which are, first, the first primary templates comprising said word and term headers in text-based interfaces and graphical user interfaces viewable useable by and interactive with said patients, physicians, devices and program for effecting the processes and products described herein and relating the contents of said information and data on said viewing screens and database or databases and wherein said program implement said repetitive processes effecting the generations, expansions, manipulations, updates and improved performances of contents of said first interactive templates and in said database or databases by said patients, physicians and program and, second, the second primary templates comprising said word and term headers in text-based interfaces and graphical user interfaces viewable useable by and interactive with said physicians and computer software and program means for effecting said processes and products and relating the contents of said information and data on said viewing screens and database or databases and, furthermore, wherein said computer software and program means implements the repetitively related contents of said second interactive template with contents of said first primary templates in said database or databases and, third, the third primary templates said program retrieves from said database or databases related said contents of said first and second primary templates for assimilations and incorporations to produce and show said related contents of first and second primary templates on said third templates which are contents-transformed said first primary templates upon assimilating or incorporating said information and data of said second primary templates and wherein said repetitive processes imposed on said second templates by said physicians and said repetitive processes imposed on said third templates by said patients, physicians and computer software and program means repetitively effect said processes and productions resulting in perpetual said expansions, updates and improvements of said third primary templates, and, (4) fourth, the fourth primary templates comprising at least four types of templates—one of which are partially synthesized by physicians and one of which are partially synthesized by patients and yet one of which partially synthesized by said computer software and program means and yet the fourth one of which are artificial-intelligently created or synthesized by said computer software and program means derived from and/or based on the information and data used by physicians wherein words, terms, phrases, sentences, texts and graphics relating to said information and data in said templates and database or databases are used by patients and physicians to enter health, health-care and health-care-service information and data into said database or databases and repetitive assimilations or incorporations of said information and data in said fourth primary templates into said third primary templates by said patients and physicians to achieve said processes and products, and, (5) fifth, numerous fifth primary templates comprising words, terms, phrases, sentences, word and term headers, texts and graphics in comprising text-based interfaces and graphical user interfaces link and/or relate to said primary templates and show information and data including details relate to said information and data in said primary templates wherein said fifth primary templates are used by physicians and patients to manipulate, update and improve said primary templates, and (6) numerous interactive secondary electronic interfaces or templates henceforth secondary templates linked to said words and terms and graphics in said primary templates comprising words, terms, phrases, sentences, word and term headers, texts and graphics in comprising text-based interfaces and graphical user interfaces relate to said words and terms and the contents of said primary templates and said database or databases viewable on the viewing screens of said devices and useable by said patients and physicians for repetitive viewing, generating, manipulating, adding, updating, expanding and/or improving said information and data and related and derivatives in said primary templates and database or databases and wherein said physicians and patients accessing said network or networks using computers, laptops and communication devices from different locations and in diverse settings, for the best management of information and data on health, health-care and health-care services generated by physicians and patients and for achieving the objectives and goals of the present invention comprises:
a process of implementing said innovative computer software and program in common commercial hardware and equipment for achieving the processes and products described herein;
a process of using said innovative computer software and program in common commercial hardware and equipment for achieving the processes and products described herein;
a process of creating said database or databases by said computer software and program;
a process of implementing said database or databases by said computer software and program;
a process of relating said information and data generated by patients and physicians in said database or databases by said computer software and program;
a process of submitting said information and data generated by patients and physicians by said patients and physicians and into said database or databases by said computer software and program;
a process of submitting said information and data generated by patients and physicians into said database or databases by said computer software and program;
a process of using said computer software and program for achieving the processes and products described herein;
a process of retrieving said information and data from said database or databases by said patients and physicians for displaying on said viewing screens of said devices;
a process of retrieving said information and data from said database or databases by said computer software and program for displaying on said viewing screens of said devices;
a process of identifying word and term headers relating to health, health-care and health-care-service information and data;
a process of displaying said word and term headers in said templates;
a process of using said word and term headers in said templates;
a process of using said word and term headers in health, health-care and health-care-service information and data on patients and physicians for organizing, inserting and storing said information and data in said database or databases;
a process of using said word and term headers in health, health-care and health-care-service information and data on patients and physicians for relating said information and data in said database or databases;
a process of using a plurality of primary interactive electronic interfaces or templates;
a process of using said first templates for generating, relating, manipulating said first health and health-care information and data on patients by patients;
a process of using said first templates for generating, relating, manipulating and expanding the contents of first health and health-care information and data on patients by physicians;
a process of using said first primary templates comprising said word and term headers and secondary templates viewable and useable by and interactive with said patients, physicians, devices and program for effecting the processes and products described herein;
a process of using said first primary templates comprising said word and term headers and secondary templates viewable and useable by and interactive with said patients, physicians, devices and program for effecting the processes and products described herein
a process of using said first primary templates and secondary templates for relating said contents of said information and data on said viewing screens;
a process of using a first primary templates for effecting the relations of said contents of said information and data in said database or databases;
a process of implementing repetitive processes of effecting said generations, expansions, manipulations, updates and improved performances of said contents of said first interactive template by said patients, physicians and computer software and program;
a process of using said second primary templates comprising said word and term headers, and other templates infra, viewable and useable by and interactive with said physicians for effecting the processes and products described herein;
a process of using said second primary templates comprising said word and term headers, and other templates infra, viewable and useable by and interactive with said physicians, devices and/or computer software and program for effecting the processes and products described herein;
a process of repetitively using said second primary templates comprising said word and term headers, and other templates infra, viewable and useable by and interactive with said physicians, devices and computer software and program for effecting the processes and products described herein;
a process of using said second primary templates, and other templates infra, for relating the contents of said information and data on said viewing screens;
a process of using said second primary templates, and other templates infra, for effecting the relations of the contents of said information and data in said database or databases;
a process of using said second templates for generating, relating, manipulating, updating and expanding second information and data on health, health-care and health-care services performed by said physicians on patients by said physicians;
a process of using said second templates for generating, relating, manipulating, updating and expanding second information and data on health, health-care and health-care services performed by said physicians on patients by said physicians for contents-transforming said first templates into said third templates;
a process of using said second templates for generating, relating, manipulating, updating and expanding second information and data on health, health-care and health-care services performed by said physicians on patients by said physicians for contents-transforming said first templates into said third templates by said computer software and program;
a process of repetitively using said second templates for generating, relating, manipulating, updating and expanding second information and data on health, health-care and health-care services performed by said physicians on patients by said physicians for contents-transforming said first templates into said third templates by said computer software and program;
a process of repetitively using said second templates for generating, relating, manipulating, updating and expanding second information and data on health, health-care and health-care services performed by said physicians on patients by said physicians for contents-transforming said first templates into said third templates by said physicians;
a process of repetitively using said secondary templates for generating, relating, manipulating, updating and expanding second information and data on health, health-care and health-care services performed by said physicians on patients by said physicians for contents-transforming said third templates by said patients;
a process of repetitively using said secondary templates for generating, relating, manipulating, updating and expanding second information and data on health, health-care and health-care services performed by said physicians on patients by said physicians for contents-transforming said third templates by said physicians;
a process of repetitively using said secondary templates for generating, relating, manipulating, updating and expanding second information and data on health, health-care and health-care services performed by said physicians on patients by said physicians for contents-transforming said third templates by said computer software and program;
a process of repetitively implementing said processes effecting the generations, expansions, manipulations, updates and improved performances of the contents of said third templates by said physicians and patients and program;
a process of repetitively implementing said processes effecting the generations, expansions, manipulations, updates and improved performances of the contents of said third templates by said computer software and program;
a process of repetitively using said second templates for generating, relating, manipulating, updating and expanding the contents of third information and data on physicians' prescriptions of medications and testings generated by said physicians;
a process of relating said information and data derived from said first primary templates and said information and data derived from said second primary templates in said database or databases by showing the assimilations or incorporations of said information and data derived from said second primary templates into said primary templates thence contents-transforming said first templates into said third templates viewable on said viewing screens and useable by said patients and physicians;
a process of repetitively relating said information and data derived from said first primary templates and said information and data derived from said second primary templates in said database or databases by repetitively showing the assimilations or incorporations of said information and data derived from said second primary templates into said primary templates thence said third templates viewable on said viewing screens and useable by said patients and physicians;
a process of using said fourth primary templates viewable and useable by and interactive with said physicians, patients, devices and program for effecting the processes and products described herein;
a process of using said fourth primary templates viewable and useable by and interactive with said physicians for effecting the processes and products described herein;
a process of using said fourth primary templates for relating the contents of said information and data on said viewing screens;
a process of using said fourth primary templates for effecting the relations of the contents of said information and data in said database or databases;
a process of repetitively using said fourth primary templates for relating the contents of said information and data on said viewing screens by said physicians;
a process of repetitively using said fourth primary templates for relating said information and data in said database or databases by said physicians;
a process of repetitively using said fourth primary templates for expanding, improving and updating information and data in said third primary templates by said physicians;
a process of repetitively using said fourth primary templates for expanding, improving and updating information and data in said third primary templates by said computer software and program;
a process of repetitively using said fourth primary templates for expanding, improving and updating information and data in said third primary templates by said patients;
a process of repetitively using said fourth primary templates for relating said information and data in said database or databases by said physicians;
a process of repetitively using said fourth primary templates for relating said information and data in said database or databases by said computer software and program;
a process of repetitively using said fourth primary templates for relating said information and data in said database or databases by said patients;
a process of using said fifth primary templates viewable and useable by and interactive with said physicians, patients, devices and program for effecting the processes and products described herein;
a process of using said fifth primary templates viewable and useable by and interactive with said physicians, devices and program for effecting the processes and products described herein;
a process of using said fifth primary templates for relating the contents of said information and data on said viewing screens;
a process of using said fifth primary templates for effecting the relations of the contents of said information and data in said database or databases;
process of repetitively using said fifth primary templates for expanding, improving and updating information and data in said third primary templates by said physicians;
a process of repetitively using said fifth primary templates for expanding, improving and updating information and data in said third primary templates by said computer software and program;
a process of repetitively using said fifth primary templates for expanding, improving and updating information and data in said third primary templates by said patients;
a process of repetitively using said fifth primary templates for expanding, improving, updating and relating information and data in said database or databases by said physicians;
a process of repetitively using said fifth primary templates for expanding, improving, updating and relating information and data in said database or databases by said computer software and program;
a process of repetitively using said fifth primary templates for expanding, improving, updating and relating information and data in said database or databases by said patients;
a process of generating, storing, relating, retrieving, manipulating, expanding and updating said health, health-care and health-care-service information and data by said computer software and program;
a process of generating, storing, relating, retrieving, manipulating, expanding and updating said health, health-care and health-care-service information and data by said patients;
a process of generating, storing, relating, retrieving, manipulating, expanding and updating said health, health-care and health-care-service information and data by said physicians;
a process of using word and term headers in for organizing and retrieving said information and data for displaying on said viewing screens of said devices for viewing and manipulating by said patients;
a process of using word and term headers in for organizing and retrieving said information and data for displaying on said viewing screens of said devices for viewing and manipulating by said physicians;
a process of using word and term headers for generating, manipulating and expanding and updating information and data on physicians' prescriptions of medications and testings and test results generated by said physicians by said physicians;
a process of using said second templates for generating, manipulating and expanding and updating information and data on physicians' prescriptions of medications and testings and test results generated by said physicians by said physicians;
a process of using word and term headers for generating, relating, manipulating and expanding and updating information and data on physicians' prescriptions of medications and testings and test results generated by said physicians by said computer software and program;
a process of repetitively using word and term headers for effecting the repetitions of said processes and products;
a process of using said secondary templates for generating, relating, manipulating and expanding the contents of said first primary templates by said patients;
a process of using said secondary templates for generating, relating, manipulating, updating and expanding for updating and manipulating, improving the contents of said second templates by said patients;
a process of using said secondary templates for generating, relating, manipulating, updating and expanding for updating and manipulating, improving the contents of said third primary templates by said patients;
a process of using said secondary templates for generating, relating, manipulating, updating and expanding second information and data on health-care services performed by said physicians on patients by said physicians and patients for updating and manipulating, improving the contents of said third templates;
a process of repetitively implementing said processes effecting the generations, expansions, manipulations, updates and improved performances of the contents of said templates by said physicians and patients;
a process of repetitively implementing said processes effecting the generations, expansions, manipulations, updates and improved performances of the contents of said templates by said computer software and program;
a process of managing tests and laboratory prescriptions, scheduling and records by said patients and physicians using said templates;
a process of managing the prescriptions, dispenses of medications and documentations of said dispenses by said patients, physicians and pharmacists;
a process of blocking or excluding individual physicians' accesses to said information and data of individual patients by said individual patients and by said computer software and program; and
a process of repetitively implementing said processes effecting the generations, relations, expansions, manipulations, updates and improved performances of said database or databases;
a process of repetitively implementing said processes effecting the generations, expansions, manipulations, updates and improved performances of the contents of said templates by said physicians and patients; and
a process of repetitively implementing said processes effecting the generations, expansions, manipulations, updates and improved performances of the contents of said templates by said computer software and program.

2. A method of implementing and using numerous interactive electronic interfaces or templates henceforth templates comprising word and term headers and related words, terms, phrases, sentences, word and term headers, texts and graphics, text-based interfaces and graphical user interfaces generated, maintain and support by an innovative computer software and program means for generating, storing, relating, manipulating, updating and expanding health, health-care and health-care service information and data on patients by said patients and physicians and pharmacists wherein said information and data are entered, stored, related, updated and expanded in the database or databases generated, maintain and support by said computer software and program means operating in a computer server or serves in a network or networks of computer servers, computers and mobile or portable electronic communication devices henceforth devices being viewed and used by patients, physicians and pharmacists and their surrogates and/or assistants for managing information and data on health, health-care and health-care services generated by said patients, physicians and patients pharmacists and their assistants wherein said templates comprising at least three primary templates which are, first, the first primary templates comprising said word and term headers in text-based interfaces and graphical user interfaces viewable useable by and interactive with said patients, physicians, devices and program for effecting the processes and products described herein and relating the contents of said information and data on said viewing screens and database or databases and wherein said program implement said repetitive processes effecting the generations, expansions, manipulations, updates and improved performances of contents of said first interactive templates and in said database or databases by said patients, physicians and program and, second, the second primary templates comprising said word and term headers in text-based interfaces and graphical user interfaces viewable useable by and interactive with said physicians and computer software and program means for effecting said processes and products and relating the contents of said information and data on said viewing screens and database or databases and, furthermore, wherein said computer software and program means implements the repetitively related contents of said second interactive template with contents of said first primary templates in said database or databases and, third, the third primary templates said program retrieves from said database or databases related said contents of said first and second primary templates for assimilations and incorporations to produce and show said related contents of first and second primary templates on said third templates which are contents-transformed said first primary templates upon assimilating or incorporating said information and data of said second primary templates and wherein said repetitive processes imposed on said second templates by said physicians and said repetitive processes imposed on said third templates by said patients, physicians and computer software and program means repetitively effect said processes and productions resulting in perpetual said expansions, updates and improvements of said third primary templates, and, (4) fourth, the fourth primary templates comprising at least four types of templates—one of which are partially synthesized by physicians and one of which are partially synthesized by patients and yet one of which partially synthesized by said computer software and program means and yet the fourth one of which are artificial-intelligently created or synthesized by said computer software and program means derived from and/or based on the information and data used by physicians wherein words, terms, phrases, sentences, texts and graphics relating to said information and data in said templates and database or databases are used by patients and physicians to enter health, health-care and health-care-service information and data into said database or databases and repetitive assimilations or incorporations of said information and data in said fourth primary templates into said third primary templates by said patients and physicians to achieve said processes and products, and, (5) fifth, numerous fifth primary templates comprising words, terms, phrases, sentences, word and term headers, texts and graphics in comprising text-based interfaces and graphical user interfaces link and/or relate to said primary templates and show information and data including details relate to said information and data in said primary templates wherein said fifth primary templates are used by physicians and patients to manipulate, update and improve said primary templates, and (6) numerous interactive secondary electronic interfaces or templates henceforth secondary templates linked to said words and terms and graphics in said primary templates comprising words, terms, phrases, sentences, word and term headers, texts and graphics in comprising text-based interfaces and graphical user interfaces relate to said words and terms and the contents of said primary templates and said database or databases viewable on the viewing screens of said devices and useable by said patients and physicians for repetitive viewing, generating, manipulating, adding, updating, expanding and/or improving said information and data and related and derivatives in said primary templates and database or databases and wherein said physicians and patients accessing said network or networks using computers, laptops and communication devices from different locations and in diverse settings, for the best management of information and data on health, health-care and health-care services generated by physicians and patients and for achieving the objectives and goals of the present invention comprises:
a process of implementing said innovative computer software and program in common commercial hardware and equipment for achieving the processes and products described herein;
a process of using said innovative computer software and program in common commercial hardware and equipment for achieving the processes and products described herein;
a process of creating said database or databases by said computer software and program;
a process of implementing said database or databases by said computer software and program;
a process of relating said information and data generated by patients and physicians in said database or databases by said computer software and program;
a process of submitting said information and data generated by patients and physicians by said patients and physicians and into said database or databases by said computer software and program;
a process of submitting said information and data generated by patients and physicians into said database or databases by said computer software and program;
a process of using said computer software and program for achieving the processes and products described herein;
a process of retrieving said information and data from said database or databases by said patients and physicians for displaying on said viewing screens of said devices;
a process of retrieving said information and data from said database or databases by said computer software and program for displaying on said viewing screens of said devices;
a process of identifying word and term headers relating to health, health-care and health-care-service information and data;
a process of displaying said word and term headers in said templates;
a process of using said word and term headers in said templates;
a process of using said word and term headers in health, health-care and health-care-service information and data on patients and physicians for organizing, inserting and storing said information and data in said database or databases;
a process of using said word and term headers in health, health-care and health-care-service information and data on patients and physicians for relating said information and data in said database or databases;
a process of using a plurality of primary interactive electronic interfaces or templates;
a process of using said first templates for generating, relating, manipulating said first health and health-care information and data on patients by patients;
a process of using said first templates for generating, relating, manipulating and expanding the contents of first health and health-care information and data on patients by physicians;
a process of using said first primary templates comprising said word and term headers and secondary templates viewable and useable by and interactive with said patients, physicians, devices and program for effecting the processes and products described herein;
a process of using said first primary templates comprising said word and term headers and secondary templates viewable and useable by and interactive with said patients, physicians, devices and program for effecting the processes and products described herein
a process of using said first primary templates and secondary templates for relating said contents of said information and data on said viewing screens;
a process of using a first primary templates for effecting the relations of said contents of said information and data in said database or databases;
a process of implementing repetitive processes of effecting said generations, expansions, manipulations, updates and improved performances of said contents of said first interactive template by said patients, physicians and computer software and program;
a process of using said second primary templates comprising said word and term headers, and other templates infra, viewable and useable by and interactive with said physicians for effecting the processes and products described herein;
a process of using said second primary templates comprising said word and term headers, and other templates infra, viewable and useable by and interactive with said physicians, devices and/or computer software and program for effecting the processes and products described herein;
a process of repetitively using said second primary templates comprising said word and term headers, and other templates infra, viewable and useable by and interactive with said physicians, devices and computer software and program for effecting the processes and products described herein;
a process of using said second primary templates, and other templates infra, for relating the contents of said information and data on said viewing screens;
a process of using said second primary templates, and other templates infra, for effecting the relations of the contents of said information and data in said database or databases;
a process of using said second templates for generating, relating, manipulating, updating and expanding second information and data on health, health-care and health-care services performed by said physicians on patients by said physicians;
a process of using said second templates for generating, relating, manipulating, updating and expanding second information and data on health, health-care and health-care services performed by said physicians on patients by said physicians for contents-transforming said first templates into said third templates;
a process of using said second templates for generating, relating, manipulating, updating and expanding second information and data on health, health-care and health-care services performed by said physicians on patients by said physicians for contents-transforming said first templates into said third templates by said computer software and program;
a process of repetitively using said second templates for generating, relating, manipulating, updating and expanding second information and data on health, health-care and health-care services performed by said physicians on patients by said physicians for contents-transforming said first templates into said third templates by said computer software and program;
a process of repetitively using said second templates for generating, relating, manipulating, updating and expanding second information and data on health, health-care and health-care services performed by said physicians on patients by said physicians for contents-transforming said first templates into said third templates by said physicians;
a process of repetitively using said secondary templates for generating, relating, manipulating, updating and expanding second information and data on health, health-care and health-care services performed by said physicians on patients by said physicians for contents-transforming said third templates by said patients;
a process of repetitively using said secondary templates for generating, relating, manipulating, updating and expanding second information and data on health, health-care and health-care services performed by said physicians on patients by said physicians for contents-transforming said third templates by said physicians;
a process of repetitively using said secondary templates for generating, relating, manipulating, updating and expanding second information and data on health, health-care and health-care services performed by said physicians on patients by said physicians for contents-transforming said third templates by said computer software and program;
a process of repetitively implementing said processes effecting the generations, expansions, manipulations, updates and improved performances of the contents of said third templates by said physicians and patients and program;
a process of repetitively implementing said processes effecting the generations, expansions, manipulations, updates and improved performances of the contents of said third templates by said computer software and program;
a process of repetitively using said second templates for generating, relating, manipulating, updating and expanding the contents of third information and data on physicians' prescriptions of medications and testings generated by said physicians;
a process of relating said information and data derived from said first primary templates and said information and data derived from said second primary templates in said database or databases by showing the assimilations or incorporations of said information and data derived from said second primary templates into said primary templates thence contents-transforming said first templates into said third templates viewable on said viewing screens and useable by said patients and physicians;
a process of repetitively relating said information and data derived from said first primary templates and said information and data derived from said second primary templates in said database or databases by repetitively showing the assimilations or incorporations of said information and data derived from said second primary templates into said primary templates thence said third templates viewable on said viewing screens and useable by said patients and physicians;
a process of using said fourth primary templates viewable and useable by and interactive with said physicians, patients, devices and program for effecting the processes and products described herein;
a process of using said fourth primary templates viewable and useable by and interactive with said physicians for effecting the processes and products described herein;
a process of using said fourth primary templates for relating the contents of said information and data on said viewing screens;
a process of using said fourth primary templates for effecting the relations of the contents of said information and data in said database or databases;
a process of repetitively using said fourth primary templates for relating the contents of said information and data on said viewing screens by said physicians;
a process of repetitively using said fourth primary templates for relating said information and data in said database or databases by said physicians;
a process of repetitively using said fourth primary templates for expanding, improving and updating information and data in said third primary templates by said physicians;
a process of repetitively using said fourth primary templates for expanding, improving and updating information and data in said third primary templates by said computer software and program;
a process of repetitively using said fourth primary templates for expanding, improving and updating information and data in said third primary templates by said patients;
a process of repetitively using said fourth primary templates for relating said information and data in said database or databases by said physicians;
a process of repetitively using said fourth primary templates for relating said information and data in said database or databases by said computer software and program;
a process of repetitively using said fourth primary templates for relating said information and data in said database or databases by said patients;
a process of using said fifth primary templates viewable and useable by and interactive with said physicians, patients, devices and program for effecting the processes and products described herein;
a process of using said fifth primary templates viewable and useable by and interactive with said physicians, devices and program for effecting the processes and products described herein;
a process of using said fifth primary templates for relating the contents of said information and data on said viewing screens;
a process of using said fifth primary templates for effecting the relations of the contents of said information and data in said database or databases;
process of repetitively using said fifth primary templates for expanding, improving and updating information and data in said third primary templates by said physicians;
a process of repetitively using said fifth primary templates for expanding, improving and updating information and data in said third primary templates by said computer software and program;
a process of repetitively using said fifth primary templates for expanding, improving and updating information and data in said third primary templates by said patients;
a process of repetitively using said fifth primary templates for expanding, improving, updating and relating information and data in said database or databases by said physicians;
a process of repetitively using said fifth primary templates for expanding, improving, updating and relating information and data in said database or databases by said computer software and program;
a process of repetitively using said fifth primary templates for expanding, improving, updating and relating information and data in said database or databases by said patients;
a process of generating, storing, relating, retrieving, manipulating, expanding and updating said health, health-care and health-care-service information and data by said computer software and program;
a process of generating, storing, relating, retrieving, manipulating, expanding and updating said health, health-care and health-care-service information and data by said patients;
a process of generating, storing, relating, retrieving, manipulating, expanding and updating said health, health-care and health-care-service information and data by said physicians;
a process of using word and term headers in for organizing and retrieving said information and data for displaying on said viewing screens of said devices for viewing and manipulating by said patients;
a process of using word and term headers in for organizing and retrieving said information and data for displaying on said viewing screens of said devices for viewing and manipulating by said physicians;
a process of using word and term headers for generating, manipulating and expanding and updating information and data on physicians' prescriptions of medications and testings and test results generated by said physicians by said physicians;
a process of using said second templates for generating, manipulating and expanding and updating information and data on physicians' prescriptions of medications and testings and test results generated by said physicians by said physicians;
a process of using word and term headers for generating, relating, manipulating and expanding and updating information and data on physicians' prescriptions of medications and testings and test results generated by said physicians by said computer software and program;
a process of repetitively using word and term headers for effecting the repetitions of said processes and products;
a process of using said secondary templates for generating, relating, manipulating and expanding the contents of said first primary templates by said patients;
a process of using said secondary templates for generating, relating, manipulating, updating and expanding for updating and manipulating, improving the contents of said second templates by said patients;
a process of using said secondary templates for generating, relating, manipulating, updating and expanding for updating and manipulating, improving the contents of said third primary templates by said patients;
a process of using said secondary templates for generating, relating, manipulating, updating and expanding second information and data on health-care services performed by said physicians on patients by said physicians and patients for updating and manipulating, improving the contents of said third templates;
a process of repetitively implementing said processes effecting the generations, expansions, manipulations, updates and improved performances of the contents of said templates by said physicians and patients;
a process of repetitively implementing said processes effecting the generations, expansions, manipulations, updates and improved performances of the contents of said templates by said computer software and program;
a process of managing tests and laboratory prescriptions, scheduling and records by said patients and physicians using said templates;
a process of managing the prescriptions, dispenses of medications and documentations of said dispenses by said patients, physicians and pharmacists;
a process of blocking or excluding individual physicians' accesses to said information and data of individual patients by said individual patients and by said computer software and program; and
a process of repetitively implementing said processes effecting the generations, relations, expansions, manipulations, updates and improved performances of said database or databases;
a process of repetitively implementing said processes effecting the generations, expansions, manipulations, updates and improved performances of the contents of said templates by said physicians and patients; and
a process of repetitively implementing said processes effecting the generations, expansions, manipulations, updates and improved performances of the contents of said templates by said computer software and program.

3. An electronic platform for generating, viewing, manipulating and expanding health and health-care information and data and health-care-service information and data generated by patients and physicians and for the communications of said health and health-care information and data and health-care-service information and data generated by said physicians and the interactions between said physicians and patients and computer servers useable by said physicians and patients who are in different locations and diverse settings, for generating, relating, storing, retrieving and enlarging said information and data in the database or databases of said computer servers, for relating the contents of said information and data, for manipulating, expanding, viewing and communicating said information and data on patients by and between said patients and physicians and for generating, relating, storing, retrieving and enlarging information and data on health-care services performed by said physicians on patients and information and for generating, relating, storing, retrieving and enlarging data on physicians' prescriptions of medications and tests and test results generated by physicians, wherein said platform, information and data, processes, matters, events and products and said database or databases and their derivatives are created, enabled, effected and maintained by an innovative computer software and program henceforth program invented and created by the present patent applicant and supported by common commercially available computer and server programs and installed and implemented in said computer servers in a network or networks of computer servers, computers and mobile or portable electronic communication devices henceforth devices, wherein said platform comprises (1) said database or databases, (2) words and terms also known as word and term headers in health, health-care and health-care-service information and data, (3) numerous primary interactive electronic interfaces or templates henceforth primary templates comprising at least three primary templates which are, first, the first primary templates comprising said word and term headers in text-based interfaces and graphical user interfaces viewable useable by and interactive with said patients, physicians, devices and program for effecting the processes and products described herein and relating the contents of said information and data on said viewing screens and database or databases and wherein said program implement said repetitive processes effecting the generations, expansions, manipulations, updates and improved performances of contents of said first interactive templates and in said database or databases by said patients, physicians and program and, second, the second primary templates comprising said word and term headers in text-based interfaces and graphical user interfaces viewable useable by and interactive with said physicians and computer software and program means for effecting said processes and products and relating the contents of said information and data on said viewing screens and database or databases and, furthermore, wherein said computer software and program means implements the repetitively related contents of said second interactive template with contents of said first primary templates in said database or databases and, third, the third primary templates said program retrieves from said database or databases related said contents of said first and second primary templates for assimilations and incorporations to produce and show said related contents of first and second primary templates on said third templates which are contents-transformed said first primary templates upon assimilating or incorporating said information and data of said second primary templates and wherein said repetitive processes imposed on said second templates by said physicians and said repetitive processes imposed on said third templates by said patients, physicians and computer software and program means repetitively effect said processes and productions resulting in perpetual said expansions, updates and improvements of said third primary templates, and, (4) fourth, the fourth primary templates comprising at least four types of templates—one of which are partially synthesized by physicians and one of which are partially synthesized by patients and yet one of which partially synthesized by said computer software and program means and yet the fourth one of which are artificial-intelligently created or synthesized by said computer software and program means derived from and/or based on the information and data used by physicians wherein words, terms, phrases, sentences, texts and graphics relating to said information and data in said templates and database or databases are used by patients and physicians to enter health, health-care and health-care-service information and data into said database or databases and repetitive assimilations or incorporations of said information and data in said fourth primary templates into said third primary templates by said patients and physicians to achieve said processes and products, and, (5) fifth, numerous fifth primary templates comprising words, terms, phrases, sentences, word and term headers, texts and graphics in comprising text-based interfaces and graphical user interfaces link and/or relate to said primary templates and show information and data including details relate to said information and data in said primary templates wherein said fifth primary templates are used by physicians and patients to manipulate, update and improve said primary templates, and (6) numerous interactive secondary electronic interfaces or templates henceforth secondary templates linked to said words and terms and graphics in said primary templates comprising words, terms, phrases, sentences, word and term headers, texts and graphics in comprising text-based interfaces and graphical user interfaces relate to said words and terms and the contents of said primary templates and said database or databases viewable on the viewing screens of said devices and useable by said patients and physicians for repetitive viewing, generating, manipulating, adding, updating, expanding and/or improving said information and data and related and derivatives in said primary templates and database or databases and wherein said physicians and patients accessing said network or networks using computers, laptops and communication devices from different locations and in diverse settings, for the best management of information and data on health, health-care and health-care services generated by physicians and patients and for achieving the objectives and goals of the present invention.
